(19) United States
(12) Patent Application Publication
(10) Pub. No.: US 2023/0096833 A1
(43) Pub. Date: Mar. 30, 2023

(54) BODY PART COLOR MEASUREMENT DETECTION AND METHOD

(71) Applicant: Abdullalbrahim Abdulwaheed, Holbrook, MA (US)

(72) Inventor: Abdullalbrahim Abdulwaheed, Holbrook, MA (US)

(21) Appl. No.: 17/391,823

(22) Filed: Aug. 2, 2021

(51) Int. Cl. G06T 11/00; G06T 7/90

(52) U.S. Cl. CPC G06T 11/001; G06T 7/90; G06T 2207/30196

(57) ABSTRACT

A method of selecting a color metric value for a body part includes capturing an image of the body part, creating a pixel map of the captured image, performing pre-processing techniques to the pixel map, the preprocessing techniques creating a processed image matrix, determining a first color metric value for the processed image matrix, adjusting the first color metric value to an updated color metric value, displaying the updated color metric value on an electronic device screen, receiving an indication from the user of acceptance or rejection of the updated color metric value, and based on receiving a rejection indication, adjusting the updated color metric value. A non-transitory computer readable medium and a system to implement the method are also disclosed.

### CLAIM OF PRIORITY

This patent application claims the benefit of priority, under 35 U.S.C. § 120, as a continuation-in-part of U.S. Non-Provisional patent application Ser. No. 16/747,040, filed Jan. 20, 2020 titled “Body Part Color Measurement Detection and Method”, now U.S. Pat. No. TBS, issued on MONTH DD, 2021; and the benefit of priority of U.S. Non-Provisional patent application Ser. No. 15/978,313, filed May 14, 2018, titled “Body Part Color Measurement Detection and Method”, which issued as U.S. Pat. No. 10,547,780 on Jan. 28, 2019. The entire contents of each are incorporated herein by reference.

### FIELD OF THE INVENTION

The present disclosure is directed to a method of detecting an accurate color measurement of a body part, such as teeth, through the strict control of both ambient and direct lighting sources. In one embodiment, a user is guided through the method using a hand held personal computing device having an integrated or external lighting source of a known color and a camera of known color acquisition characteristics. By careful control of lighting and image acquisition, the relative whiteness of a user's body part in the form of a whiteness score or percentage can be determined.

### BRIEF DESCRIPTION OF THE DRAWINGS

FIG. 1 is a flowchart showing the components of an embodiment of the system;

FIG. 2 is a flowchart showing the method of using the system of FIG. 1 for calibration of an electronic device and providing an initial color score to a user;

FIG. 3 is an environmental view of the manner in which a user begins the process shown in the flowchart depicted in FIG. 2;

FIG. 4 is an environmental view depiction a subsequent step of the process begun in FIG. 3;

FIGS. 5-12 are close-up views of the display of the electronic device being used in the process depicted in FIG. 2 and illustrate the subsequent steps of the process;

FIG. 13 is a flowchart showing the steps of acquiring images of a user's teeth as well as obtaining color scores thereof using a stored calibration profile;

FIG. 14 is a close-up view of the display of the electronic device with a the graphical components of a stored calibration profile superimposed on the user interface;

FIG. 15 is a close-up view of the display of the electronic device shown in FIG. 14 wherein a user is shown positioning their face on the screen in using the stored calibration profile as a visual guide and in accordance with the steps put forth in the method depicted in FIG. 13;

FIG. 16 is a front view of a color chart apparatus for use as an alternative or to supplement the step of obtaining an initial image in a darkened room as shown in FIGS. 3-4;

FIG. 17 is a front view of an alternative embodiment to the color chart apparatus shown in FIG. 16;

FIG. 18 is a front view of an alternative embodiment to the color chart apparatuses shown in FIGS. 16 and 17;

FIG. 19 is a front view of an alternative embodiment to the color chart apparatuses shown in FIG. 16-18; and

FIG. 20 is a flowchart showing the steps of creating a color score in accordance with embodiments.

### DETAILED DESCRIPTION

As indicated above, embodiments of the present disclosure are directed primarily to a computer based application or “app” such as may be utilized by smart phones or similar portable computing devices equipped with a camera. The app of the present disclosure provides guidance in the form of direction for controlling all lighting sources and carefully controlling image acquisition in order to measure the color of a desired region of a user's facial anatomy, such as their teeth.

Because facial anatomy includes several amorphous angulations, with less than distinct margins relative comparisons of anatomical color are difficult. Inconsistent ambient lighting, distance from a camera to the user, angle of the camera, etc. all act to make consistent and objective image comparisons of color and color quality nearly impossible without the techniques described herein. When utilized in the manner discussed and described herein, the method of the present disclosure overcomes these known limitations and provides lighting instructions, a lighting source, an image acquisition mechanism, and image acquisition instructions in a mobile solution for determining the color of facial anatomy using standardized metrics.

The method utilizes operations to standardize various aspects of the image detection and capture process including standardizing the level of ambient lighting during image detection, establishing a set distance and angulation of the camera relative to the user, providing mechanisms to clearly outline and differentiate the desired facial anatomy (teeth) of interest from adjacent areas. The captured image of the user's teeth is then measured and analyzed by the application to provide a whiteness score, and or a color score relevant to another anatomical structure, that may be compared to other users' whiteness scores and/or one's own scores over time. The user can differentiate a placebo outcome from that of an actual outcome when provided with the whiteness (and/or color) score.

The term “whiteness score” and/or “color score”, is a measure of the closeness in color hue that a particular body part is to a target color. Target colors can be preselected (e.g., a whiteness score can have as its target color any shade, tint, hue, light frequency). It is within the contemplation of this disclosure that a color score can be obtained for any target color — white, black, brown, red, blue, et al.

Embodying methods include mechanical steps which allow a user to create a controlled environment for capturing an image and subsequently calculating a color/brightness score of a portion of a user's anatomy. An embodying method provides steps to control ambient lighting and camera distance from a user in order to create a reproducible environment for image capture.

In one embodiment, the portion of the user's anatomy of which a color score is to be obtained is the user's teeth. The embodiment is described herein, but the methods described are applicable to other embodiments as well, such as: for determining a score of a user's skin or of cosmetics applied thereto, the determination of a color score of an anatomical feature such as a mole or blemish, determining a color score for a user's hair, etc.

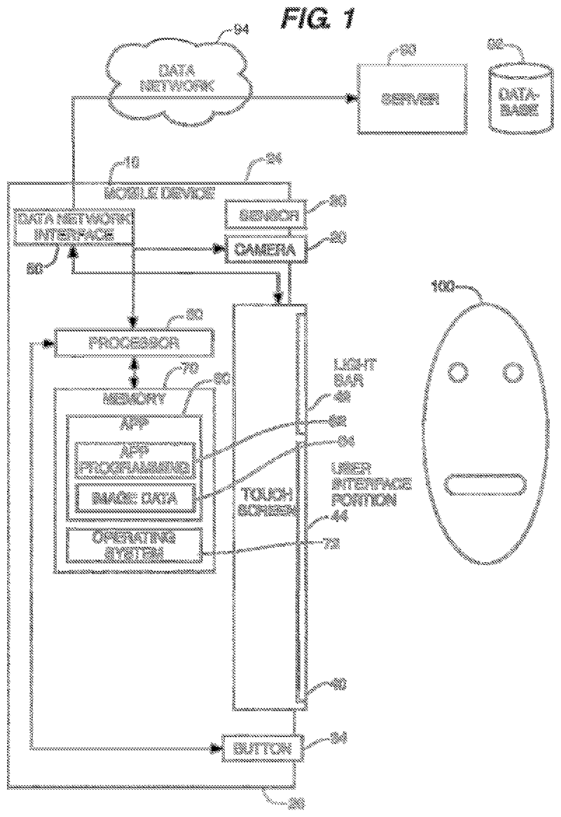

One embodiment makes use of a computer program or application (app) stored in the electronic memory of a portable electronic device 10 in order to control the method. As is shown in FIG. 1, the device 10 can take the form of a smart phone that is equipped with a camera 20, a user interface or touch screen 40 that performs multiple functions in this embodiment, and network connectivity 50 to allow the portable electronic device 10 to connect with a remote server 90 and its associated database 92 over a wide area network 94, such as the Internet. The application (“app”) 60 resides on the memory 70 of the device 10. The application 60 generally takes the form of computer instructions 62 that are designed to be executed on a computer processor 80. In one embodiment, the processor is an ARM-based processor developed pursuant to the specifications of Arm Holdings of Cambridge, UK. The application 60 may also contain data 64, such as image data created by the app 60. In some embodiments, the app 60 only temporarily stores data 64 within the device 10, with the intent of the primary data storage of images created by the app 60 being the database 92 accessed through server 90. In order for the device 10 to function as a smart phone and perform other functions, the memory 70 can contain programming that provides the operating system 72 of the device, such as the iOS from Apple Inc. (Cupertino, Calif.) or ANDROID OS from Google Inc. (Menlo Park, Calif.).

In function and use the application 60 guides the user through a process that allows the user to detect, measure and display the color or color value of any particular area of facial anatomy, such as for example the whiteness of a user's teeth in the form of a percentage value or score. The app 60 can provide instructions to the user 100 to perform the appropriate steps of the method through the touch screen 40. In one embodiment, the app 60 can divide the screen 40 into two portions. A first portion 42 is proximal to the camera 20 and is used to provide a consistent light source near that camera. This is accomplished by providing a rectangle of light (a “light bar”) 42 on the touch screen 40. Because the app 60 has the ability to control the content of the touch screen, the intensity and the color of the light bar 42 can be adjusted to ensure a consistent image of the user's facial feature. The light bare 42 is adaptive to the size of the device's screen size, and screen ratio and configured to emit the correct quality of light (and quantity) in terms of color temperature and luminosity therefrom.

The second portion 44 is the user interface portion, which can provide written and video instructions for performing the method, and to provide an image of what the camera 20 is viewing at a particular time. In circumstances where an image is not about to be acquired, the light bar 42 can be removed from the screen 40 to allow the entire screen to be used for the user interface 44.

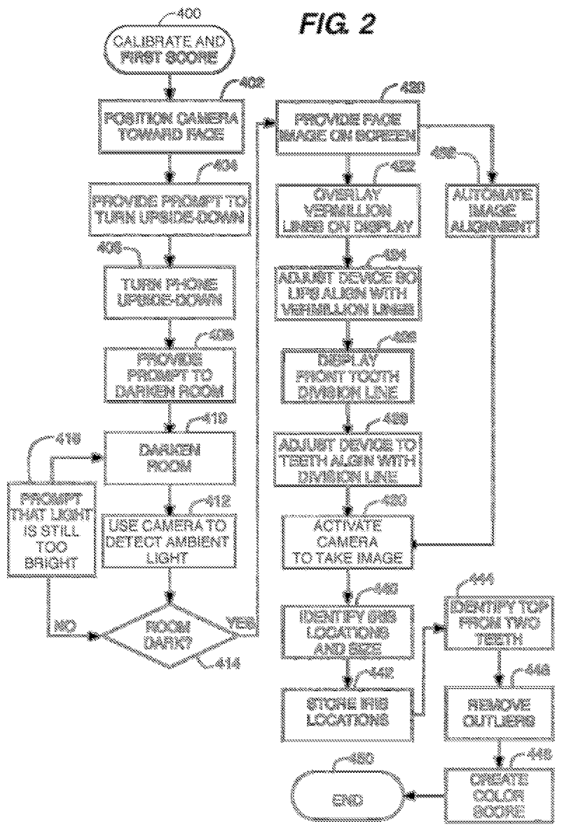

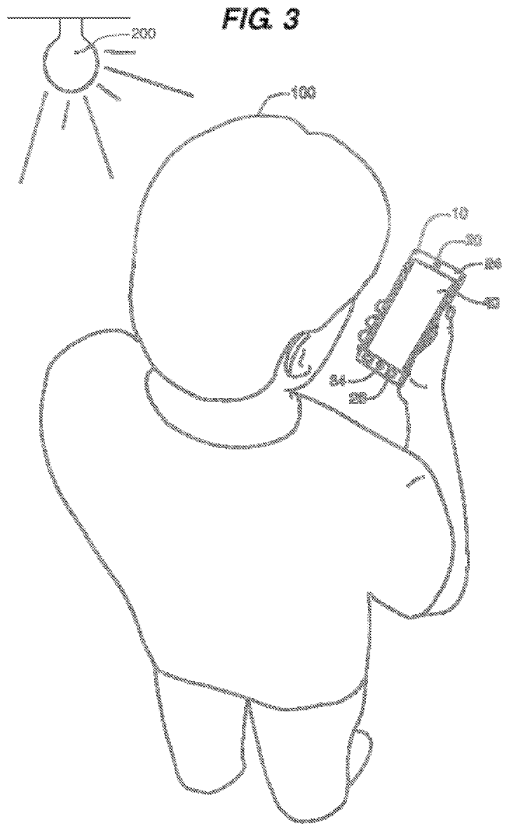

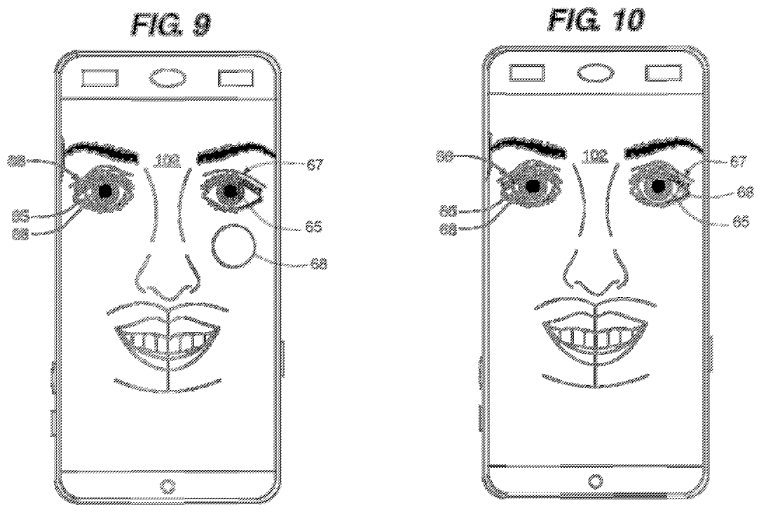

Before the application can provide the whiteness score of a user's teeth, the phone 10 and the application 60 can be calibrated so as to provide imagery of a consistent quality so that the relative whiteness score is measured from a relatively stable and constant baseline of environmental conditions. The calibration process 400 is set forth in the flowchart found on FIG. 2. For purposes of this discussion, method 400 is presented in the context of the elements of FIG. 1 and the general use illustrations shown in FIGS. 3-12. However, the invention is not so limited, and it should be readily understood that other embodiments and implementations are within the scope of this disclosure.

The method begins with the user 100 holding the phone 10 in front of their face so that the user-side camera 20 is able to detect and display a real time image of the user's face on the display screen 40, such as in the manner shown in FIG. 3 and represented in step 402 of the operational flowchart of FIG. 2.

Most smart-phones, such as phone 10 shown in FIG. 3, have a top 24 and a bottom 26 with such relative terms being applied from the perspective of the user. In the embodiment shown in FIG. 3, the phone 10 includes the camera 20 (lens), and other elements ubiquitous to phones such as a speaker, etc. Proximal to the bottom 26 of the phone 10 is a user control or home button 34.

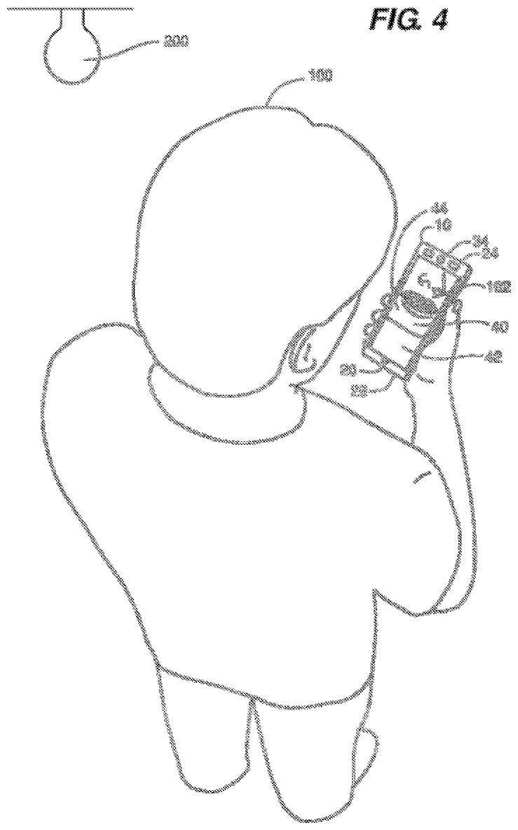

As part of the calibration process, as represented in block 404 of the operational flowchart of FIG. 2, the application can provide an audio and/or visual prompt to appear on the screen 40 for the user to turn the phone 10 “upside down” or to “turn the phone over 180 degrees”, etc. so that the camera 20 is now positioned at the bottom 26 of the phone from the perspective of the user 100, such as in the manner shown in FIG. 4 (step 406 of FIG. 2). In this position the camera 20 is better positioned to detect and display an image of the user's face on the screen 40. The application 60 can display the image of the user's face 102 on that portion of the interface portion of the screen 40. Note that the user's face can appear “right side up” on the display screen 40 despite the camera 20 being inverted.

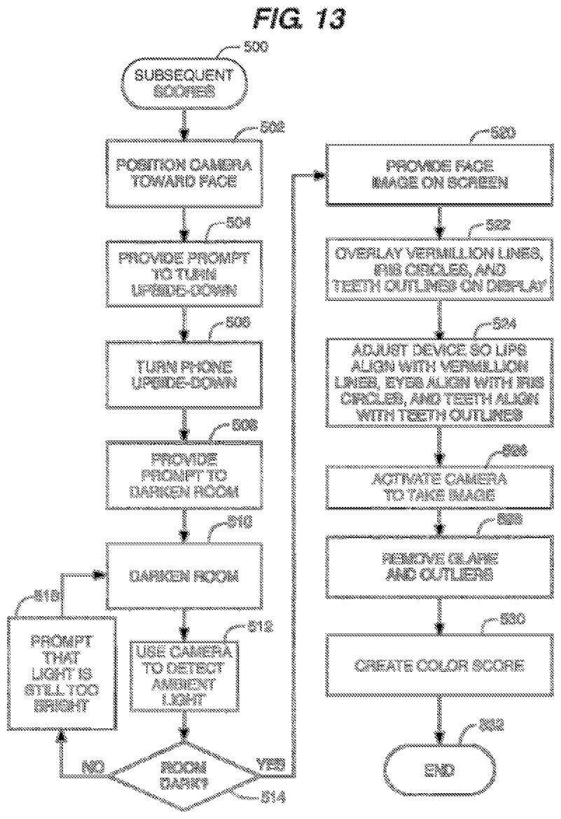

In some embodiments the application is in communication with the internal gyroscope or other orientation mechanism of the phone so as to measure the tilt of the phone or device 10. When the user's face 102 is properly positioned within the confines of the user interface 44 the application may record the tilt of the device upon initial image capture/calibration and utilize that recorded tilt in future image capture processes (see FIG. 13) to ensure that the user's face is properly aligned with the device 10.

At this point in the calibration process, the application can also prompt the user 100 to make sure to “turn off all the lights in a room” or to “go into a darkened room”, etc. As illustrated in FIGS. 3 and 4, light source 200 is turned off to properly obtain and display the image of the user's face 102 on the screen 40.

Instead of relying on the impossible to predict or control ambient light of a given environment, the calibration process relies instead on the light emitted from the screen 40 to illuminate the user 100 in order to obtain and display the image of the user's face 102.

When obtaining the image 102, the phone 10, via executing the computer instructions 62 for the application 60, creates a partial screen 44 on the display 40, which that shows the subjects face; with a residual screen 42 acting as a predetermined light emission source. An example of the application providing the partial screen 40 and residual screen (light source) 42 on the display screen 40 of the phone 10 is shown in FIG. 4. The residual screen 42 is illuminated to emit lighting of a specific color temperature. By varying the R G B values of individual pixels, and the intensity of the pixel emission, a variety of source light temperatures are possible.

In some embodiments, the phone 10 can have one or more light sensors 30 (see FIG. 1). If the ambient illumination (light that the phone is exposed to from light source 200 or other environmental light sources, even when such sources are minimized or turned off) that the phone 10 is exposed to exceeds an application determined limit, the application can place a prompt on the display screen 40 (and/or provide and audio indication) that the light level is too bright to proceed with calibration and the calibration process can be placed on hold until the ambient light level is below the required threshold.

The above process of prompting the user 100 to go to a darkened room in order to provide consistent illumination of the user's face, and obtain an image thereof, using the camera 20 and light sensor 30 as well as the illumination provided by the residual screen 42 is depicted in steps 408, 420, 412, 414, 416, and finally 420 of the flowchart shown in FIG. 2.

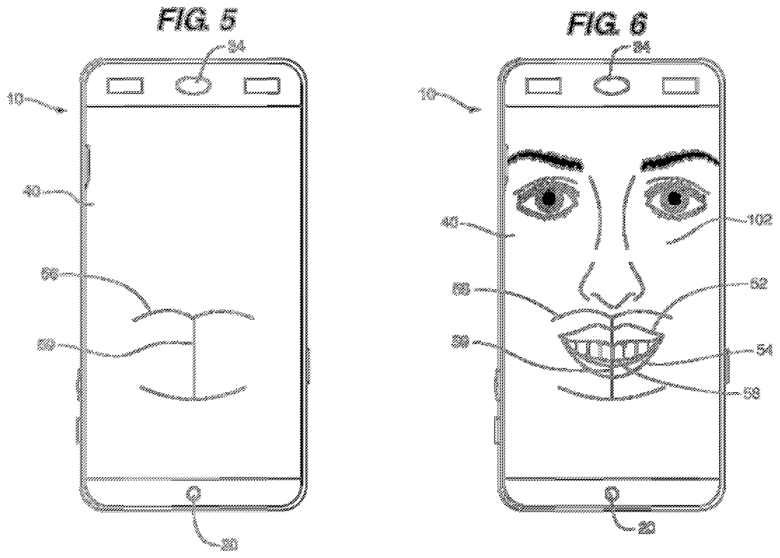

To standardize distance between the camera 20 and the target (the face of the user 100), the user 100 can position his or herself in such as manner so as to align his/her upper vermillion border 52 and lower vermillion border 54 (i.e. lips) within a schematic outline or “guide lines” 56 that the application superimposes graphically upon the display screen 40 during the image capture process such as in the manner shown in FIGS. 5 and 6, and at process steps 422 and 424 of the flowchart shown in FIG. 2. The application may prompt the user to “smile” before or during this step. In some embodiments, the upper vermillion border may consist of a specific anatomical shape contiguous with the philtrum (i.e. the region between the nose and upper lip of the user).

In addition to aligning the upper vermillion border 52 and lower vermillion border 54 within guide lines 56, preferably while the user is smiling or otherwise exposing at least some of their teeth, in at least one embodiment the user 100 can also align the line or gap 58 between of his/her central incisors with a superimposed mid-line 59 that the application also graphically produces on the display screen 40 such as in the manner shown in FIG. ban, and at steps 426 and 429 of the flowchart shown in FIG. 2.

Once the lips and teeth are properly aligned and in place within the superimposed graphics 56 and 59, the user may activate the camera to capture the image of the user's face 102 in accordance with step 430 of the FIG. 2 flowchart. The image 102 may also be automatically recorded by a computer utilizing facial recognition technology, such as is represented by block 432 of the flowchart shown in FIG. 2. The distance between the upper and lower vermillion border, along with the midline and its angulation is fixed as is the distance between the user and the device.

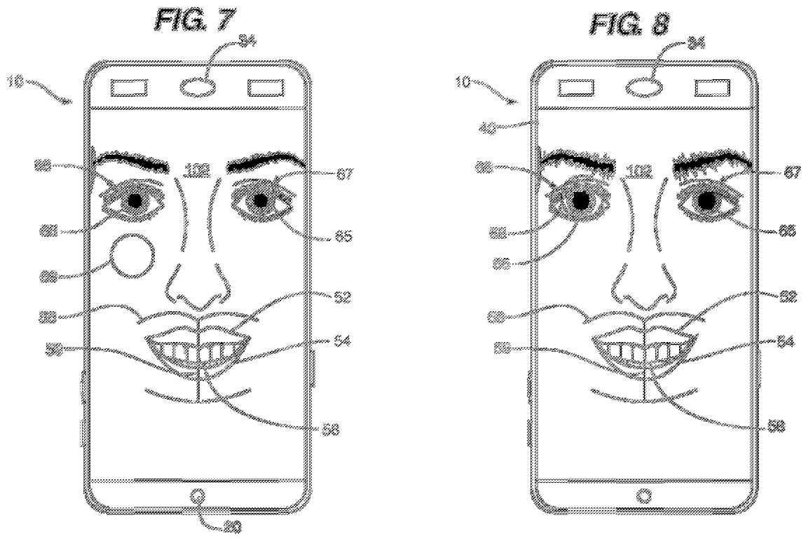

As shown in the sequence of steps illustrated in FIGS. 7-10, and at blocks 440 and 442 of the FIG. 2 flowchart, following capture of the image 102, the user 100, using the touch screen interface functionality of the display 40 via their finger, stylus, mouse, or by automatic detection provided by the application, marks the location of the iris 65 of the left eye 66 and then right eye 67 of the user's face as shown in the captured image. The act of marking the irises may be done by encircling the respective areas of the eyes with a graphical indicator (e.g. a drawn circle) 68 that the application superimposes onto the display 40. The indicator 68 is moved, as well as enlarged or reduced as necessary, via the graphical interface of the display 40 such as by common interface commands applied by contact with the interface with the user's finger, stylus, etc. to be placed over and fully encircle each iris such as in the manner shown.

By identifying the precise position of the two eyes 66 and 67, and the upper vermillion borders 52 and lower vermillion borders 54, and the midline 59, the user's position and distance for all future measurements are locked in three dimensions.

Regarding the application's use of the irises 65 of the eyes 66 and 67 to act as markers of the user's fascial anatomy for calibrating the distance and position of the user's face 102 relative to the device 10; it should be noted that the use of the irises 65 in this manner is but one potential distinct bilateral markers that could be utilized be the application for this purpose. In some embodiments for example, features such as a user's nostrils, ears, other aspects of the eyes, etc. could be used provide such a bilateral marker to act as a reference for the application.

Once the captured imaged is locked in this manner the application stores the graphical indicators 68 representing the location of the users' irises 65, and their position relative to the guide lines 56 and mid-line 59 into device 10 memory 60 as a calibrated profile or reference that can be used in subsequent image capture processes as described below. In accordance with embodiments, positional registration of other body parts can be made using other indicia—e.g., abdominal structures can be registered in relation to the belly button (for instance using one or more polar coordinates).

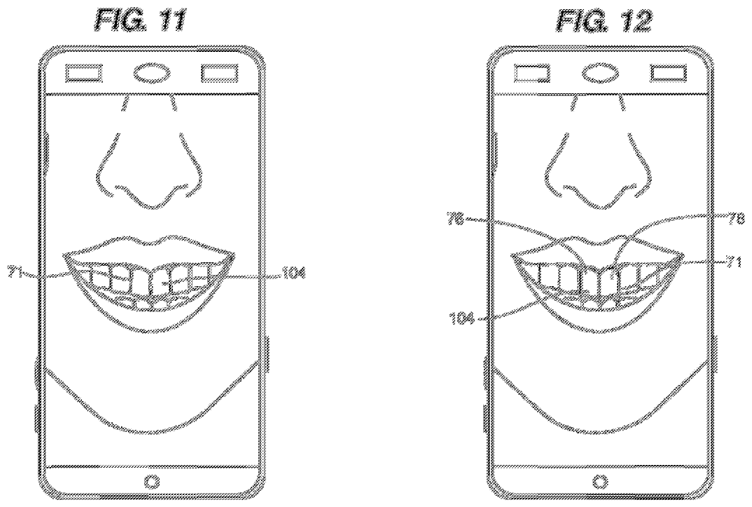

The user is then prompted by the application to use the interface functionality of the screen 40 to “zoom in” onto the image of the teeth 104 that had been framed within the guide lines such as in the manner shown in FIG. 11. The application can prompt the user to “draw” or trace on the screen with a finger or stylus, so as to place an outline 71 around the front teeth of the image 102, such as in the manner shown in FIG. 12 and at process step 444 of FIG. 2. The outline 71 is a graphically created line superimposed onto the image 102/104 which follows the tracing of the user's finger, stylus, etc. on the screen 40. By sufficiently zooming in on the desired area of the teeth 104 the outlining of the teeth is made far easier, even when done by tracing the teeth with a finger along the screen. The application allows the user to place the graphical outline 71 on individual teeth or multiple teeth together.

The pixel content of the outlined teeth 104 as defined by the outlined area or areas 76 and 78, shown in FIG. 12, is sent to the server 90 and database 92 (via the interface 50 and network 94) by the application. At process step 444, via statistical analysis such as is described in U.S. Pat. No. 9,478,043 of Abdulwaheed (titled “Measuring Teeth Whiteness System and Method”), the entire contents of which are incorporated herein by reference, the pixels are filtered and glare is removed; and a whiteness or color score is calculated.

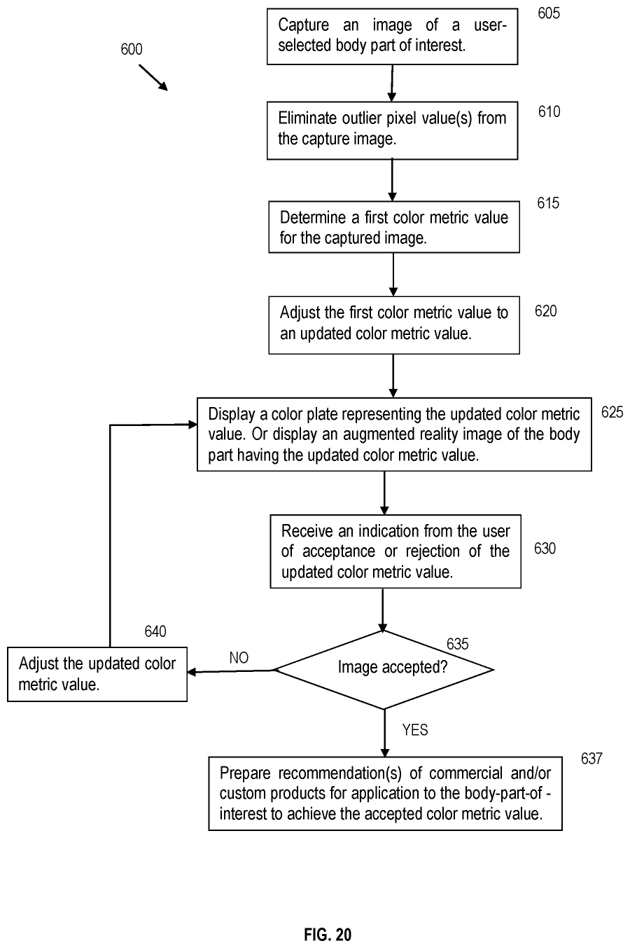

Following these calculations, the server 90, at step 448 shown in FIG. 2, communicates with the application 60 to provide the color score, which is displayed on the user interface portion 44 of the device display 40. The color score is derived from an examination of the color value (such as R-G-B color values) of the pixels within the outlined area or areas 76 and 78, wherein pixels that vary greatly from the typical value within the area(s) are discarded as outliers. The processor/application develops an average color value for the remaining pixels, and applies an algorithm (FIG. 20) to develop a 1-100 score which is the color score displayed to the user. Once this score is displayed, at step 448, the application ends the process at step 450 after a preset period of time displaying the score or upon an input from the user. In some embodiments, the application may provide a visual prompt on the interface 44 to encourage or allow the user to restart the calibration process, obtain another score, or close the application.

In some embodiments, multiple portable electronic devices, and their associated applications are linked to the central server 90. In some embodiments, the server/individual applications can compare a given user's color score or scores with those of other users, and return a normalized percentile score compared to other users. Historical values for a given user can be compared with the most recent color score obtained in order to determine and track any improvement in a user's color score.

In some embodiments, a user's color score or stored imagery may be used to trigger the provision of diagnostic information and/or product recommendations that the server and application can display on the interface 44 following a prompt or automatically. In at least one embodiment the application can provide a prompt or inquiry message to appear on the screen 40 which asks if the user had been using a product and/or treatment method, the frequency of use, the method of use, and/or other parameters in association with the score being provided.

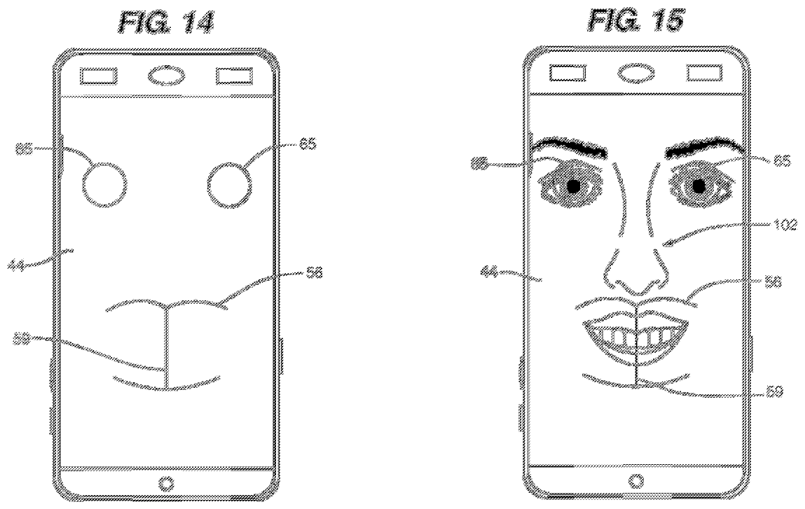

The application 60 is configured to store the calibrated profile obtained by following the calibration process depicted in FIG. 2. At a later time, post calibration, the user may perform a separate image capture process, of which its steps 500-532 are depicted in FIG. 13, to determine their color scores over time without having to recalibrate the application again. This second (and/or any subsequent capture) can follow much of the procedure described above, but can utilize the user's stored vermilion, iris and mid-line positions, depicted by their representative graphically superimposed outlines 56, 59 and 65 that the application can store and then subsequently present on the interface 44 during the subsequent image capture process (step 522) such as in the manner shown in FIG. 14. These guidelines are provided, along with prompts provided by the application, and displayed on the interface 44 and/or via the phone's speaker (not shown) to guide the user to properly position their face 102 within the frame of the display screen 40 provided by the phone's camera 20 in the manner shown in FIG. 15. When the user's face is properly positioned relative to the recorded facial feature positions shown on the display 40 (see process steps 522 and 524), the photo is taken (step 526) and the subsequent image is captured, stored and processed in the manner previously described.

Subsequent images may then be compared to one another and to the original calibration image so as to note progress of a teeth whitening process over time, note the possible development of deterioration such as may be caused by cavities or tooth decay, or simply note the condition of one's smile over time.

In accordance with embodiments, calibration can provide the user with other anatomical guides. For example, initially a standard (predetermined) silhouette of lips and teeth can be presented to guide the user to align features for image capture. Once the user is aligned with the predetermined silhouette, an image is recorded. The user could then be prompted to outline the margins of an additional set of anatomy—e.g., the specific outline of a tooth, nose, etc. This new silhouette can be stored. When the user goes to reassess his/her anatomy, the custom silhouette can be used to better align the body part features. In accordance with embodiments, the first captured calibration image can be utilized to create a transparent silhouette to help further improve alignment. Refinement of additional custom silhouettes can result in more accurate positioning of the user's body part.

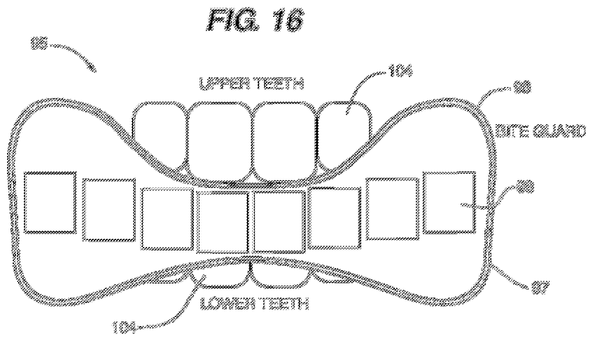

Turning now to FIGS. 16-19 wherein 4 embodiments of a color chart apparatus or “color card” 95 are shown. A color card may be utilized in situations wherein the user 100 is unable to provide a sufficiently dark environment to proceed with initial image capture and calibration such as is discussed in regards to FIG. 3-4 above. In such an instance a color card 95 such as is shown in FIG. 16-19 may be utilized to allow the application 60 to proceed with image capture and calibration despite the presence of excess environmental illumination.

In the embodiments shown in FIGS. 16-18 the color card 95 is provided in the form of a mouth guard 96 that has colored blocks or other areas 97 of specified and known color values 98 which are held adjacent to the anatomy which a color score is desired (in this case teeth 104). The colored areas 98 are preferably based on a CMYK color model, but alternative models may be utilized as well as long as the application is configured to compare the known values of the colored areas 98 to the colors of the image obtained with the color card present.

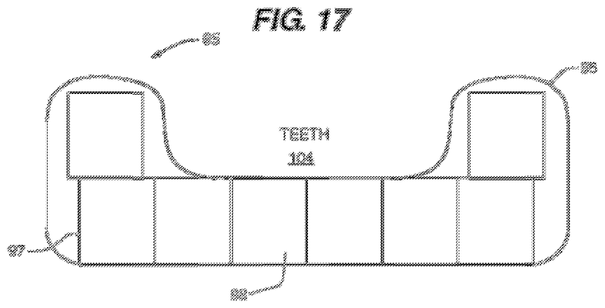

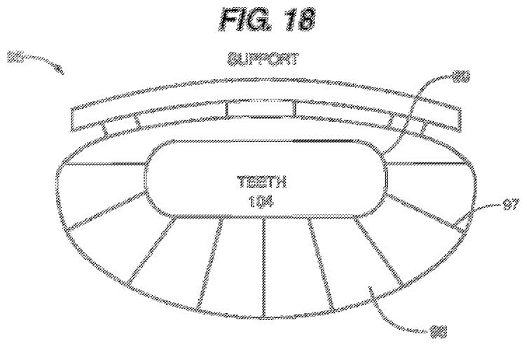

In the embodiment shown in FIG. 16 the mouth guard 96 is configured as a member which the user 100 bites down upon such that the areas 97 are within the view of the camera 20 (see FIGS. 3-4) during initial image capture as shown and described above. In an alternative embodiment, shown in FIG. 17, the mouth guard 96 is shaped such that only the upper teeth 104 of the user are shown when the mouth guard is in place. In another embodiment, shown in FIG. 18, the color card 95 is configured as a lip support (as opposed to a mouth guard per se) that is positioned behind the lips of the user but in front of the teeth 104, and opening 99 within the card 95 allows the teeth 104 to be exposed when the card 95 is properly positioned.

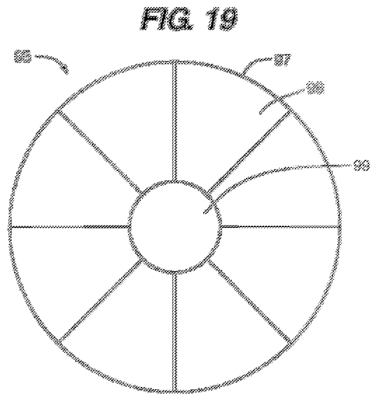

Finally, in FIG. 19, a universal manually positionable card 95 is shown, which consists of the card 95 with a hole 99 centrally positioned therein and surrounded by the colored areas 97. The card 95 is sized to allow a user (not shown) to simply hold or place the card 95 over any desired part of the anatomy to which a color score is desired. While the teeth of the user may be scored using this configuration of the color card 95, this configuration is more ideal for imaging and scoring the skin (e.g. analyzing the degree of a tan obtained or pigment changes of a mole, etc.) or hair (e.g. to determining the effectiveness of a hair coloring product).

FIG. 20 depicts a flowchart of an algorithm 600 that creates a color score (FIG. 2, step 448; FIG. 123, step 530) in accordance with embodiments. An image of the body part is captured, step 605. The captured image content is determined by the user aligning the displayed image with an outline representing the body part of interest. The outline is provided by the app 60 on the device screen.

The image is captured by the device 10. The image is analyzed, step 610, where the analysis can include eliminating outlier pixel values from the image's pixel matrix and other preprocessing data manipulation.

The processed image matrix can be traversed to access the RGB value of each pixel. The R, G, B values of the visited pixel are compared to the corresponding average RGB value. If the current value is larger than that pixel's corresponding RGB value by a predetermined factor, then neighboring pixels are adjusted. A kernel window is used to determine the adjustment value. The center pixel of the kernel window can be the current visited pixel

In the kernel window, if the number of pixel that the R, G, B value of which are both larger than the corresponding average R, G, B value, it is determined that the kernel section is a glare. To eliminate the glare from the current image, the R, G, B value of all pixels in the glare are replaced with the corresponding average R, G, B value.

In accordance with embodiments, the following process can be implemented to reduce and/or eliminate glare from the image of the body part. A matrix of pixel values is created from the image. This image matrix can be evaluated to access corresponding RGB values for each pixel. These RGB pixel values can be summed, and an average RGB value for the image calculated.

To better position the captured image's area of interest, an internal process pads the number of border pixels to move the area of interest more into the middle of the pixel window

In accordance with embodiments, noise (e.g., salt-and-pepper noise, and/or other noise depictions within the image) can be reduced and/or removed. The app 60 computes the median of all the pixels under the kernel window. The central pixel is replaced with this median value. When implemented with Gaussian and box filters, the filtered value for the central element can be a value which may not exist in the original image. However this is not the case in median filtering, since the central element is always replaced by some pixel value in the image. This reduces the noise effectively.

The analysis can assign, step 615, a first color metric value to the body part within the captured image's outline. At step 620, the color metric can be adjusted to a second color metric value. This color metric adjustment can be made to brighten the image. In some implementations, the color metric can be adjusted to darken the body part image.

The color metric value can be displayed on the portable electronic device 10, step 625, as a color image plate representing the color metric value. In some embodiments, an image of the captured body part adjusted to the current color metric value can be displayed as an augmented reality image. A user can evaluate, step 630, the augmented image to evaluate their opinion on their acceptance or rejection of the body part with the updated color metric.

If the color metric value is accepted by the user, step 635, recommendation(s) can be generated to provide commercial and/or custom products to apply to the body-part-of-interest to achieve this accepted color metric value, step 637. If not accepted by the user, the color metric can be updated, step 640, to another or a previous color metric. For example, if the current measured color metric value score=65, then user can select score 75 to evaluate that appearance. In accordance with embodiments, should the user consider the current color metric value to be too white, or bright, a prior color metric value can be retrieved from memory storage.

Process 600 returns to step 625 to display the adjusted color metric value. In accordance with embodiments, the user can make multiple selections of color metric values. Each of these selected values can be stored for later retrieval and display.

After implementing a treatment plan, the user can launch process 600 so that the present color metric value of the body part of interest can be captured. This present value can be compared to an initial value, or intermediary values to judge the progress of the treatment plan.

A treatment plan can be implemented by the user for treating the body part of interest to change the body part from its present color metric to a second color metric. After implementing a treatment plan, the user can launch process 600 so that the present color metric value of the body part of interest can be captured. This present value can be compared to an initial value, or intermediary values to judge the progress of the treatment plan.

Any treatment plan result(s) (e.g. a color change in the color metric value associated with a certain product or treatment plan) can be stored and compared with results made using alternative products and/or treatment plans. Accordingly, the user can compare the results of a treatment plan using various products and determine one or more products which satisfy the user in achieving the desired second color metric for that body part of interest.

In accordance with embodiments, the user's demographic information can be used to provide an average color metric value for his/her peers based on age, gender, location, occupation, etc. The provided color metric value can be used as a base recommended target color metric value. Thus, in an embodiment, a goal color metric value can be identified and recommended to the user.

In accordance with embodiments, individual data can be stored in database 92. This data can include captured image(s), initial color metric, subsequent color metrics (e.g., after treatment(s)), and a user's demographic information (gender, age, ethnicity, location, etc.). The individualized data can be aggregated to form an anomynized data set. Information from the anomynized data set can be filtered and/or sorted based on the user's demographic information to obtain relevant data. Suggestions for updated color metric values can be made to a user by comparing the individual's difference from the filtered relevant data. For example, the average color metric value for a population of similar demographics in the user's location can be provided. Product and/or treatment reccomendations can be targeted using filtered data from similar users. By examining individual user data, suggestions can be made based on correlating changes in a user's prior color metric value to those products and/or treatments appied prior to the user obtaining that color metric value.

In one implementation, embodying systems and methods can be used to monitor a patient's health. For example, an initial (or prior) color metric value for a patient inflicted with jaundice can be compared to that patient's current color metric. Doctors can assess the extent of the disease's condition remotely. The doctor can assess a treatment's progress, and adjust the treatment if needed.

In another implementation, skin tone reccomendations for a variety of ethnicities can be made by evaluating filtered, anonymized data. This filtered data can also be used to recommend makeup product; or recommend a tanning regime. An Asian and caucasion can have different tanning goals. Reccomendations can be made using the filtered, anomynized, ethnocentric data.

In accordance with embodiments, the image-capture sequences (FIGS. 2 and 13), can be altered if the user has already captured the particular body part of interest to be measured. If the user is operating the app 60 for the first time, the app loads an image preview screen. In preview screen, the user can check if the body part of interest is aligned correctly. If correct the user can confirm by activating a radio button on the display. If not properly aligned, the user can activate a retake button to realign the image.

If the user has previously captured image(s) for the body part of interest, the app 60 can instruct the user to align the body part with an outline of the prior image, with the alignment silhouette(s). Once aligned, the user can activate the confirm button. Once confirmed, the app can truncate the current image based on the prior image's outline. Pre-processing techniques can be used to reduce (or eliminate) artifacts in the image—e.g., glare can be removed from the current image; further, mathematically outlying pixels can be removed. The processed image's pixel data can then be analyzed.

In accordance with an embodiment of the invention, a computer program application stored in non-volatile memory or computer-readable medium (e.g., register memory, processor cache, RAM, ROM, hard drive, flash memory, CD ROM, magnetic media, etc.) may include code or executable computer instructions 62 that when executed may instruct or cause a controller or processor to perform methods discussed herein such as a method for detecting, measuring, and displaying the color (and/or color value) of a body part.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and data configurations have been described herein, note that any number of other configurations may be provided in accordance with embodiments of the invention. Thus, while there have been shown, described, and pointed out fundamental novel features of the invention as applied to several embodiments, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

1. A method of selecting a color metric value for a body part, the method comprising:
providing an executable application to a portable electronic device having a processor and display screen;
the application causing the processor to perform the method, the method including:
capturing an image of the body part;
creating a pixel map of the captured image;
performing pre-processing techniques to the pixel map, the preprocessing techniques creating a processed image matrix;
determining a first color metric value for the processed image matrix;
adjusting the first color metric value to an updated color metric value;
displaying the updated color metric value on an electronic device screen;
receiving an indication from the user of acceptance or rejection of the updated color metric value; and
based on receiving a rejection indication for the updated color metric value, adjusting the updated color metric value to another color metric value.

2. The method of claim 1, the updated color metric value being selected by the user.

3. The method of claim 1, the displaying step including displaying a color plate representing the updated color metric value or an augmented reality image of the body part having the updated color metric value

4. The method of claim 1, the adjusted updated color metric value being a new color metric value or a previously displayed color metric value.

5. The method of claim 1, including basing an initial adjustment of the first color metric to the updated color metric value by including demographic information of the user.

6. The method of claim 1, including based on receiving an acceptance indication, preparing at least one recommendation of products to achieve the accepted color metric value

7. The method of claim 1, including:
filtering an anonymized data set by applying demographic information of the user to obtain an average color metric value corresponding to the demographic information; and
suggesting a color metric value based on the average color metric value, the suggested color metric being a higher value or a lower value that the user's current color metric.

8. The method of claim 1, including:
displaying on the screen a predetermined silhouette of the body part of interest;
receiving an indication that the body part of interest is aligned with the predetermined silhouette;
capturing an image on the mobile electronic device;
generating a custom silhouette from the captured image; and
displaying the custom silhouette on the screen for subsequent body part alignment.

9. A non-transitory computer readable medium having stored thereon instructions which when executed by a processor cause the processor to perform a method of selecting a color metric value for a body part, the method comprising:
providing an application to a portable electronic device having a processor and display screen;
the application causing the processor to perform the method, the method including:
providing an application to a portable electronic device having a processor and display screen;
the application causing the processor to perform a method, the method including:
capturing an image of the body part;
creating a pixel map of the captured image;
performing pre-processing techniques to the pixel map, the preprocessing techniques creating a processed image matrix;
determining a first color metric value for the processed image matrix;
adjusting the first color metric value to an updated color metric value;
displaying the updated color metric value on an electronic device screen;
receiving an indication from the user of acceptance or rejection of the updated color metric value; and
based on receiving a rejection indication for the updated color metric value, adjusting the updated color metric value.

10. The computer readable medium of claim 9, further including executable instructions to cause the processor to perform the method, including the updated color metric value being selected by the user.

11. The computer readable medium of claim 9, further including executable instructions to cause the processor to perform the method, the displaying step including displaying a color plate representing the updated color metric value or an augmented reality image of the body part having the updated color metric value

12. The computer readable medium of claim 9, further including executable instructions to cause the processor to perform the method, including the adjusted updated color metric value being a new color metric value or a previously displayed color metric value.

13. The computer readable medium of claim 9, further including executable instructions to cause the processor to perform the method, including basing an initial adjustment of the first color metric to the updated color metric value by including demographic information of the user.

14. The computer readable medium of claim 9, further including executable instructions to cause the processor to perform the method, including based on receiving an acceptance indication, preparing at least one recommendation of products to achieve the accepted color metric value.

15. The computer readable medium of claim 9, further including executable instructions to cause the processor to perform the method, including:
displaying on the screen a predetermined silhouette of the body part of interest;
receiving an indication that the body part of interest is aligned with the predetermined silhouette;
capturing an image on the mobile electronic device;
generating a custom silhouette from the captured image; and
displaying the custom silhouette on the screen for subsequent body part alignment.

16. The computer readable medium of claim 9, further including executable instructions to cause the processor to perform the method, including:
filtering an anonymized data set by applying demographic information of the user to obtain an average color metric value corresponding to the demographic information; and
suggesting a color metric value based on the average color metric value, the suggested color metric being a higher value or a lower value that the user's current color metric.
